(19) United States
(12) Patent Application Publication
(10) Pub. No.: US 2023/0113719 A1
(43) Pub. Date: Apr. 13, 2023

(54) IMAGE FORMING APPARATUS

(71) Applicant: Tomoaki Suga, KANAGAWA (JP)

(72) Inventor: Tomoaki Suga, KANAGAWA (JP)

(73) Assignee: Ricoh Company, Ltd., Tokyo (JP)

(21) Appl. No.: 17/932,721

(22) Filed: Sep. 16, 2022

(30) Foreign Application Priority Data
Oct. 13, 2021 (JP) 2021-168172

(51) Int. Cl. G03G 15/00

(52) U.S. Cl. CPC G03G 15/6567; G03G 15/607

(57) ABSTRACT

An image forming apparatus includes an image forming device, a reading device, and processing circuitry. The image forming device forms a first image on a first face of a recording medium and form a second image on a second face of the recording medium. The first face and the second face are on opposite sides of the recording medium. The reading device detects a shape of the recording medium. The processing circuitry corrects the second image to be formed on the second face of the recording medium with respect to the first image formed on the first face of the recording medium based on the shape of the recording medium.

### CROSS-REFERENCE TO RELATED APPLICATION

This patent application is based on and claims priority pursuant to 35 U.S.C. § 119(a) to Japanese Patent Application No. 2021-168172, filed on Oct. 13, 2021, in the Japan Patent Office, the entire disclosure of which is hereby incorporated by reference herein.

### BACKGROUND

### Technical Field

Embodiments of the present disclosure relate to an image forming apparatus.

### Related Art

Techniques are known of correcting and aligning images formed on both sides of a recording medium in a case where an image forming apparatus performs image formation on both sides of the recording medium (hereinafter, one side of both sides of the recording medium is referred to as a “first face” and a side different from the first face is referred to as a “second face”).

For example, an image forming apparatus forms an image on each of a first face and a second face of a recording medium. Next, the image forming apparatus detects the position of the image formed on each of the first face and the second face of the recording medium. Then, the image forming apparatus performs alignment of image and correction of an error of magnification based on a detection result. As described above, a technique is known to accurately adjust image positions and image sizes on both sides of the recording medium in duplex printing.

### SUMMARY

Embodiments of the present disclosure described herein provide a novel image forming apparatus including an image forming device, a reading device, and processing circuitry. The image forming device forms a first image on a first face of a recording medium and form a second image on a second face of the recording medium. The first face and the second face are on opposite sides of the recording medium. The reading device detects a shape of the recording medium. The processing circuitry corrects the second image to be formed on the second face of the recording medium with respect to the first image formed on the first face of the recording medium based on the shape of the recording medium.

### BRIEF DESCRIPTION OF THE DRAWINGS

Amore complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus according to an embodiment of the present disclosure;

FIG. 2 is a diagram illustrating a configuration of a reading device according to an embodiment of the present disclosure;

FIG. 3 is a flowchart of overall processing according to a first embodiment of the present disclosure;

FIG. 4 is a diagram illustrating a sheet according to an embodiment of the present disclosure;

FIGS. 5A and 5B are diagrams illustrating a configuration of a mechanism of correcting a posture of the sheet, according to an embodiment of the present disclosure;

FIG. 6 is a diagram illustrating an example in which the posture of the sheet is corrected;

FIG. 7 is a diagram illustrating an example in which an image is formed on a first face of the sheet;

FIG. 8 is a diagram illustrating an example of shape detection;

FIG. 9 is a diagram illustrating an example in which the sheet is reversed;

FIG. 10 is a diagram illustrating an example in which the posture of the sheet is corrected after reverse;

FIG. 11 is a diagram illustrating an example of correction and image formation of a second image on a second face of the sheet;

FIG. 12 is a flowchart of overall processing according to a second embodiment of the present disclosure;

FIG. 13 is a flowchart of overall processing according to a third embodiment of the present disclosure; and

FIG. 14 is a diagram illustrating a functional configuration of an image forming apparatus according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Descriptions are given of an image forming apparatus according to an embodiment of the present disclosure, with reference to the attached drawings. Note that the embodiments are not limited to the specific examples described below. Hereinafter, a description is given of the image forming apparatus with a sheet functioning as a recording medium.

### First Embodiment

Overall Configuration

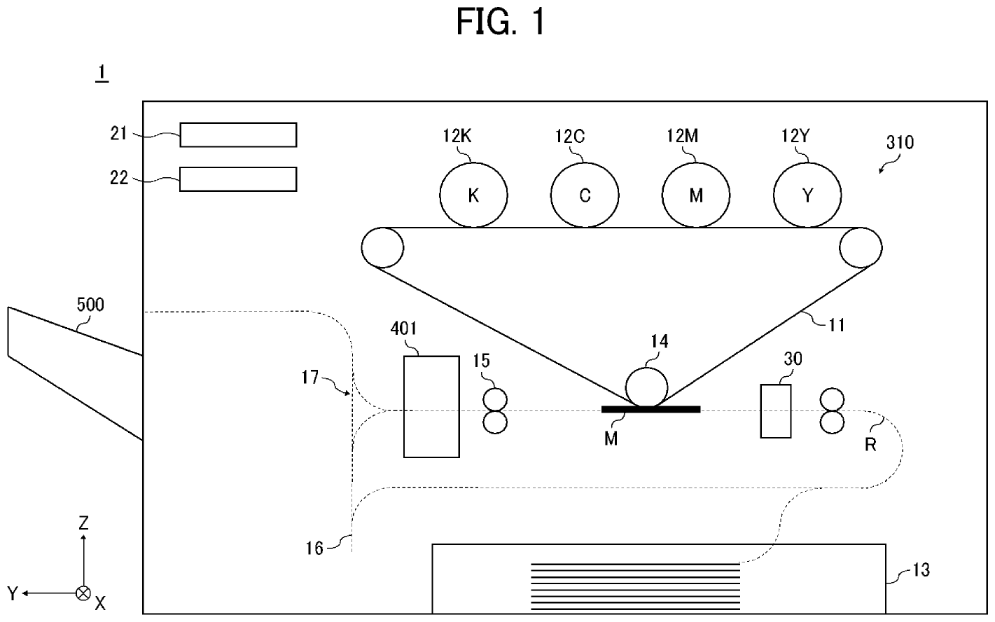

FIG. 1 is a diagram illustrating an overall configuration of an image forming apparatus according to an embodiment of the present disclosure. Hereinafter, a conveyance direction of a recording medium is referred to as a “Y direction”. In addition, a direction orthogonal to the conveyance direction of the recording medium is referred to as an “X direction”. Further, a direction orthogonal to an X-Y plane is referred to as a “Z direction”.

An image forming apparatus 1 includes a black photoconductor 12K, a cyan photoconductor 12C, a magenta photoconductor 12M, and a yellow photoconductor 12Y. Each photoconductor applies toner to a conveyance belt 11.

The conveyance belt 11 transfers an intermediate transfer image to a sheet M.

A sheet feeding tray 13 feeds the sheet M to a printer 310. Then, the sheet M passes through a sheet conveyance passage R and is conveyed to a transfer roller 14. The transfer roller 14 transfers the intermediate transfer image on the conveyance belt 11 onto the sheet M.

A fixing roller pair 15 serving as a fixing device fixes an image transferred from the conveyance belt 11 onto the sheet M.

A reading device 401 reads the image formed on the sheet M. The reading device 401 is, for example, an optical sensor.

The reading device 401 optically reads the image such as a position detection mark formed on the sheet M.

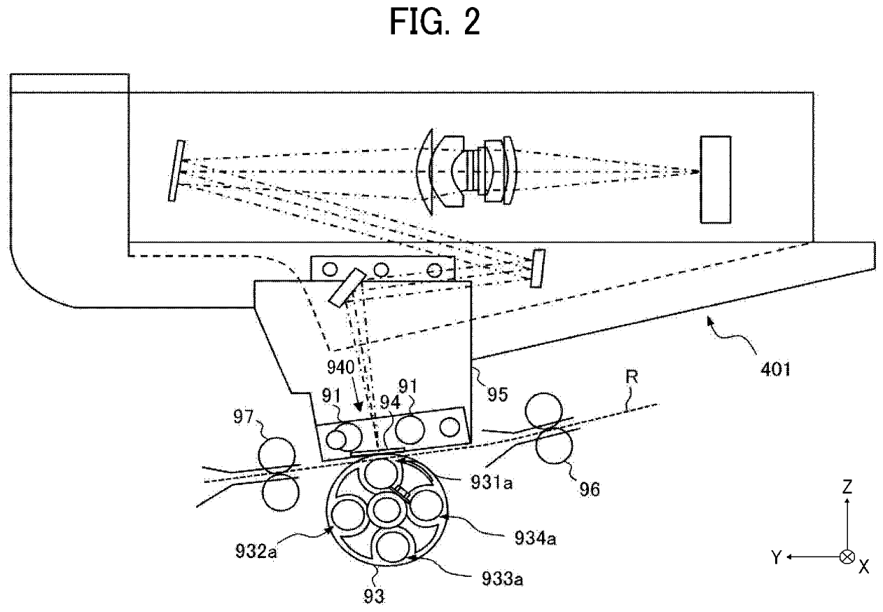

FIG. 2 is a diagram illustrating a configuration of a reading device according to an embodiment of the present disclosure. FIG. 2 is also a diagram illustrating a main part of a mechanical configuration.

The reading device 401 includes illumination light sources 91, an opposing member 93, an exposure glass 94, and a support 95.

The illumination light sources 91 are disposed facing the side on which an image is formed with respect to the sheet M. The illumination light sources 91 emit light to a reading position at which a sensor reads an image formed on the sheet M in the sheet conveyance passage R.

The reading device 401 includes optical components such as a reflecting mirror, an imaging lens, and an image sensor including an image pickup device. Alternatively, the reading device 401 may be a line sensor in which image pickup devices are arranged. The reading device 401 reads an image formed on the sheet M with the image pickup device.

The opposing member 93 includes outer circumferential surfaces 931a, 932a, 933a, and 934a. The opposing member 93 is disposed facing the back side of the side on which the image is formed with respect to the sheet M. In addition, the opposing member 93 has a configuration in which a roller is rotatably held with a roller bracket. The roller includes the outer circumferential surfaces 931a, 932a, 933a, and 934a that serve as reference surfaces that are convexly curved. The roller is also a rotatable rotary body and rotates separately from the roller bracket. Further, the outer circumferential surfaces 931a, 932a, 933a, and 934a are disposed at positions facing the exposure glass 94.

The reading position is located at a position closest to the exposure glass 94. The exposure glass 94 is a light-transmissive member. The exposure glass 94 is disposed facing the side of the sheet M on which an image is formed.

The illumination light sources 91 and the reading device 401 are fixed to the support 95.

The reading device 401 includes a first conveyance roller pair 96 upstream from the opposing member 93 in a conveyance direction of the sheet M in the sheet conveyance passage R. On the other hand, the reading device 401 includes a second conveyance roller pair 97 downstream from the opposing member 93 in the conveyance direction of the sheet M in the sheet conveyance passage R.

As the sheet M is conveyed, the reading device 401 reads the image from a side indicated by an arrow 940, through the exposure glass 94. The first conveyance roller pair 96 and the second conveyance roller pair 97 serving as a conveyance device rotate with conveyance of the sheet M.

Note that the reading device 401 may have a configuration other than the above-described configuration.

In FIG. 1, in a case where images are formed on both sides (i.e., a first face and a second face) of the sheet M, the sheet M is conveyed in different directions at a branch 17. Specifically, in a case where image formation on both sides is completed, the sheet M is conveyed so as to advance (e.g., upward in FIG. 1) through the branch 17 to a sheet ejection tray 500.

On the other hand, in a case where image formation is performed on the second face after image formation on the first face is completed, the sheet M is conveyed so as to advance (e.g., downward in FIG. 1) through the branch 17 to a sheet reverse passage 16. Thereafter, the sheet M is conveyed from the sheet reverse passage 16 to the printer 310.

The image forming apparatus 1 includes a central processing unit 21 (hereinafter referred to as “CPU 21”) and a memory 22.

The CPU 21 is an example of an arithmetic device and a control device.

The memory 22 is a random access memory (RAM), a read only memory (ROM), an auxiliary storage device, or a combination of these memories and device.

The image forming apparatus 1 causes the CPU 21 and the memory 22 to cooperate with each other to execute processing. Note that the image forming apparatus 1 may further include an auxiliary device, an input device, and an output device. The number of each of the arithmetic device, the control device, the storage device, the input device, and the output device is not limited to one and may be plural.

Example of Overall Processing

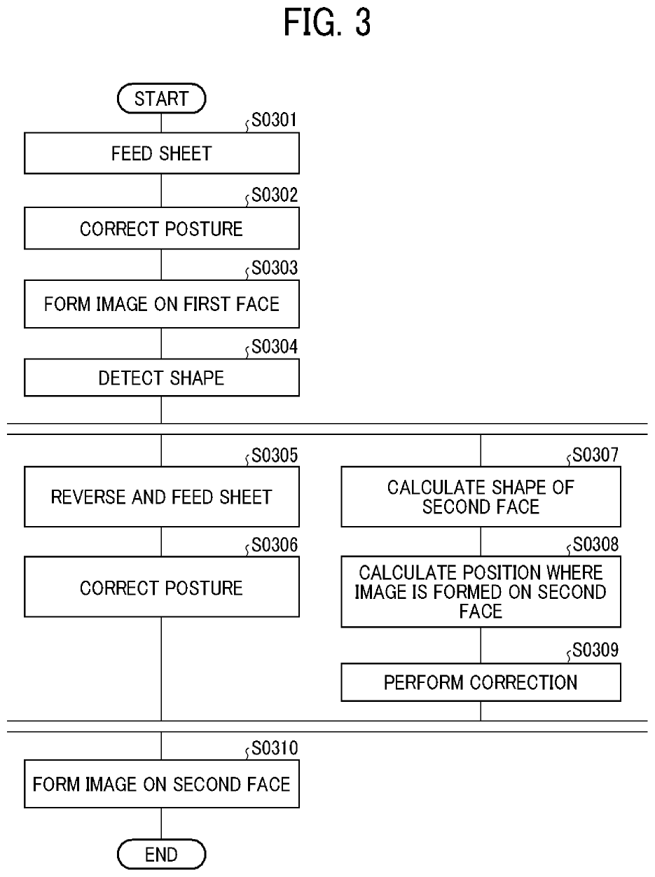

FIG. 3 is a flowchart of overall processing according to the first embodiment of the present disclosure.

In step S0301, the image forming apparatus 1 feeds a sheet M.

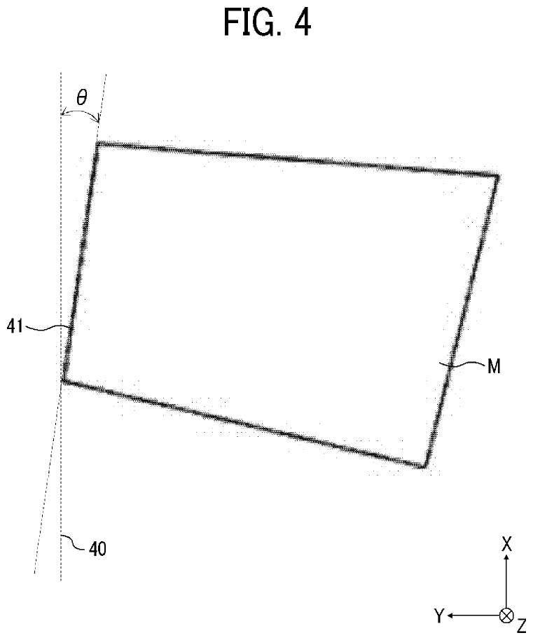

FIG. 4 is a diagram illustrating an example of the sheet M. Hereinafter, the sheet M is assumed to be conveyed in the shape and posture as illustrated in FIG. 4. The shape of the sheet M may be simply referred to as “shape” in the description below.

In FIG. 4, the reference is indicated by a “reference line 40”. The reference line 40 is a virtual line parallel to the axis (X axis) in the X direction described above. The state illustrated in FIG. 4, which is the state before the posture of the sheet M is corrected, is a state in which an edge (a first edge 41 in FIG. 4) serving as the leading end of the sheet M has an inclination θ with respect to the reference line 40. In other words, in the state illustrated in FIG. 4, the inclination θ is not zero degree of the angle, and the first edge 41 is inclined with respect to the reference line 40.

In step S0302, the image forming apparatus 1 desirably corrects the posture of the sheet M. For example, the image forming apparatus 1 corrects the posture of the sheet M by a mechanism described below.

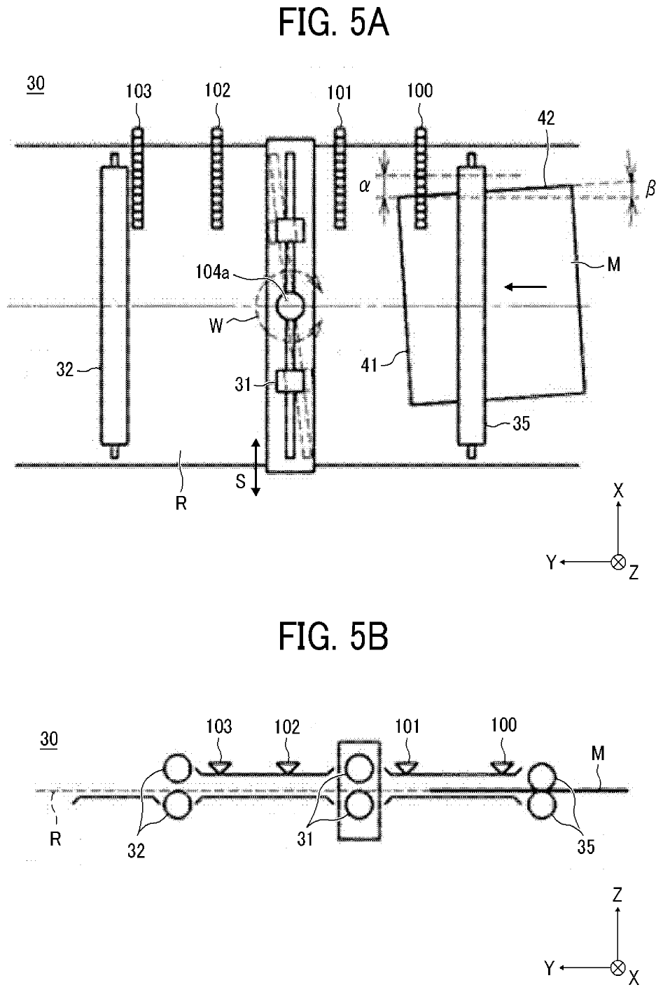

FIG. 5 is a diagram illustrating a configuration of the mechanism of correcting the posture of the sheet M, according to an embodiment of the present disclosure. Note that FIG. 5A is a plan view and FIG. 5B is a side view. Hereinafter, a device having the mechanism of correcting the posture of the sheet M is referred to as a “conveyance device 30”.

The position of the sheet M is detected with a plurality of contact image sensors (hereinafter referred to as “CISs”).

The CIS is a device using a light emitting diode (LED) as a light source. The CIS is a linear sensor that receives light via a lens and reads an image formed on the sheet M. Hereinafter, four CISs included in the conveyance device 30 are referred to as a “first CIS 100”, a “second CIS 101”, a “third CIS 102”, and a “fourth CIS 103” in order from the upstream side (the right side in FIGS. 5A and 5B) in the conveyance direction of the sheet M in the sheet conveyance passage R.

The first CIS 100 and the second CIS 101 are disposed upstream from a nip roller pair 31 in the conveyance direction of the sheet M in the sheet conveyance passage R. On the other hand, the first CIS 100 and the second CIS 101 are disposed downstream from a conveyance roller pair 35 in the conveyance direction of the sheet M in the sheet conveyance passage R.

The third CIS 102 and the fourth CIS 103 are disposed downstream from the nip roller pair 31 in the conveyance direction of the sheet M in the sheet conveyance passage R. On the other hand, the third CIS 102 and the fourth CIS 103 are disposed upstream from a timing roller pair 32 in the conveyance direction of the sheet M in the sheet conveyance passage R.

The first CIS 100, the second CIS 101, the third CIS 102, and the fourth CIS 103 are disposed in the width direction of the sheet M, in other words, in parallel with the X-axis. The relative positions of the first CIS 100, the second CIS 101, the third CIS 102, and the fourth CIS 103 in the conveyance direction, in other words, in the Y-axis are set in advance. The relation of positions of the first CIS 100, the second CIS 101, the third CIS 102, and the fourth CIS 103 with respect to the nip roller pair 31 are set in advance.

The first CIS 100, the second CIS 101, the third CIS 102, and the fourth CIS 103 detect an edge such as the first edge 41 or a second edge 42.

The sensor is not limited to the CIS and may be any other type of sensor that can detect the shape or the edge of the sheet M.

The nip roller pair 31 serving as a correction device corrects the posture of the sheet M. Specifically, the nip roller pair 31 corrects the positional deviation of the sheet M in the width direction. In the example illustrated in FIG. 5A, the positional deviation of the sheet M in the width direction is a “deviation amount α”.

Further, the nip roller pair 31 corrects an oblique angle of the sheet M with respect to the conveyance direction. In the example illustrated in FIG. 5A, the oblique angle of the sheet M with respect to the conveyance direction is an “angle β”.

In order to correct the angle β, the nip roller pair 31 rotates around an axle 104a in the Y-X plane. In the example illustrated in FIG. 5A, the nip roller pair 31 rotates in the rotation direction W. The axis of rotation of the nip roller pair 31 is located in the middle of the length of the nip roller pair 31 in the X direction in FIG. 5A. However, the axis may be located at any other position at which the nip roller pair 31 can correct the posture of the sheet M. Further, the nip roller pair 31 moves in the width direction to correct the deviation amount α. In the example illustrated in FIG. 5A, the nip roller pair 31 moves in a moving direction S.

The mechanism of correcting the posture of the sheet M is not limited to the configuration and the degree of freedom illustrated in FIGS. 5A and 5B. In other words, the mechanism may have any other configuration in which the mechanism can correct the posture of the sheet M by moving and rotating the sheet M. For example, the mechanism may be a mechanism that maintains the sheet M parallel to the conveyance direction.

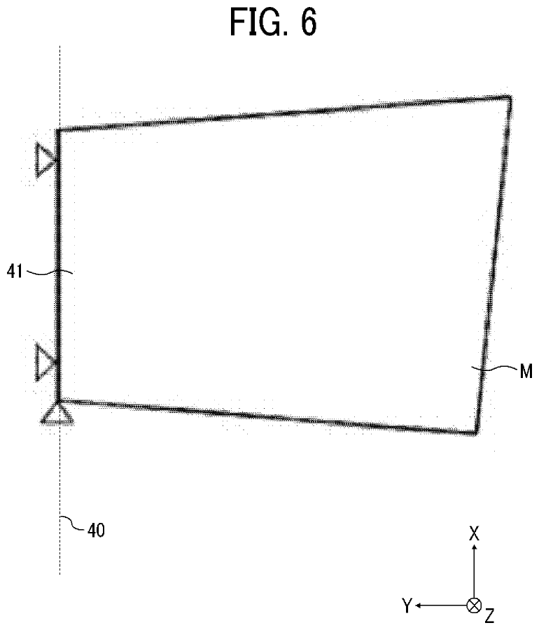

FIG. 6 is a diagram illustrating an example in which the posture of the sheet M is corrected. FIG. 6 is different from FIG. 4 in that the posture of the sheet M is corrected such that the first edge 41 matches with the reference line 40.

Note that how to correct the posture is set in advance.

In step S0303, the image forming apparatus 1 forms an image on the first face of the sheet M. For example, the image forming apparatus 1 forms an image on the first face on the sheet M as described below. Hereinafter, an image to be formed on the first face of the sheet M is referred to as a “first image IMG1”.

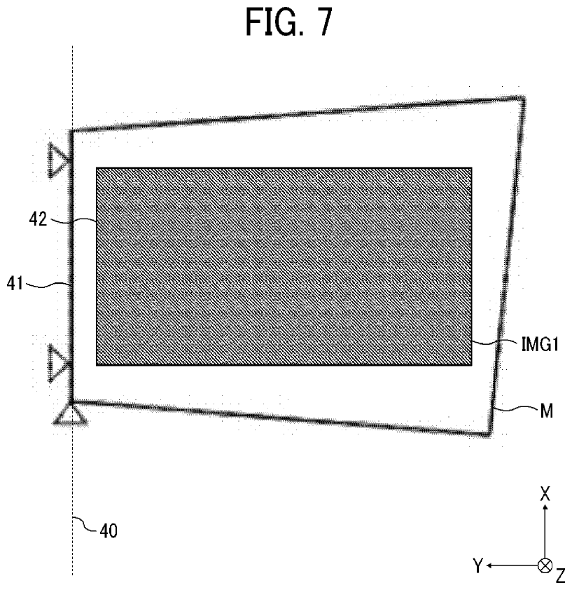

FIG. 7 is a diagram illustrating an example in which an image is formed on the first face of the sheet M. Descriptions are given of an example in which the first image IMG1 is formed such that one edge of the first image IMG1 is parallel to the reference line 40 as illustrated in FIG. 7. Specifically, a leading edge (hereinafter referred to as “second edge 42”) of the first image IMG1 among the four edges of the first image IMG1 is parallel to the reference line 40.

Hereinafter, the image formed on the second face of the sheet M is referred to as a “second image IMG2”.

A user image area is an area on the sheet M in which the user can instruct image formation of the first image IMG1 and the second image IMG2. First, images that the user instructs to form, i.e., the first image IMG1 and the second image IMG2 are input as data such as image data to the image forming apparatus 1 in advance.

For example, the user image area is an area determined by excluding an area used for mark formation and post-processing (e.g., an area used when punching processing is performed) from the overall area of the sheet M. As a result, in a case where a large user image area is obtained, a large image can be formed on the sheet M.

In step S0304, the image forming apparatus 1 detects the shape of the sheet M.

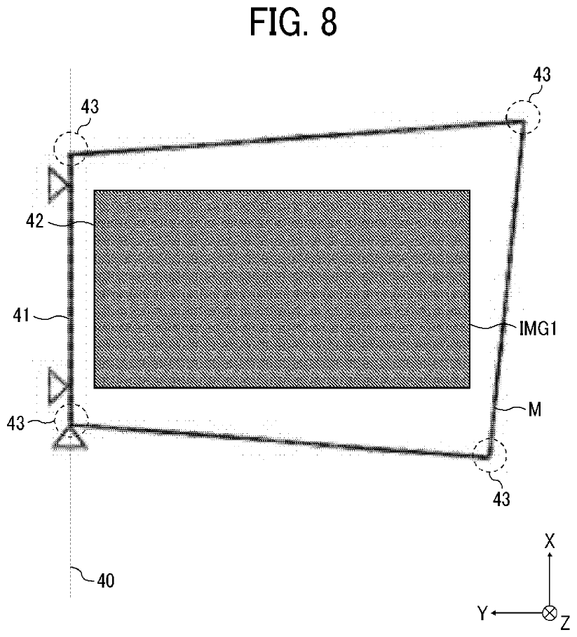

FIG. 8 is a diagram illustrating an example of shape detection. The shape is determined by detecting the positions of the four corners of the sheet M as described below. In FIG. 8, the four corners are indicated by “points 43”.

Note that the shape of the sheet M may be detected at positions other than the four corners of the sheet M. For example, the shape of the sheet M may be detected by identifying four edges of the sheet M.

The shape of the sheet M is desirably detected after the first image IMG1 is fixed on the sheet M. Heat is applied to the sheet M in the fixing. As a result, the heat generated by the fixing reduces the water included in the sheet M and reduces the size of the sheet M in many cases.

In step S0305, the image forming apparatus 1 reverses and feeds the sheet M to form an image on the second face of the sheet M. When the sheet M in the state illustrated in FIG. 8, i.e., the sheet M on which an image is formed on the first face is reversed, the sheet M is in the state described below.

Accordingly, the detection of the shape of the sheet M is desirably performed after the fixing of an image on the sheet M, i.e., the change of the shape of the sheet M occurs. As illustrated in FIG. 1, when the reading device 401 is disposed downstream from the fixing roller pair 15 in the conveyance direction of the sheet M in the sheet conveyance passage R, the image forming apparatus 1 can detect the shape of the sheet M after fixing an image on the sheet M. As described above, when the shape of the sheet M is detected at the timing after the change due to the fixing of an image on the sheet M, the sheet M can be aligned with high accuracy.

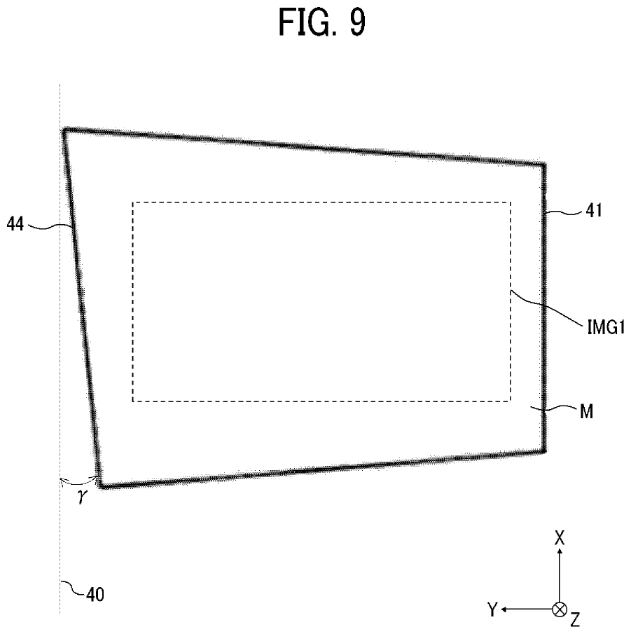

FIG. 9 is a diagram illustrating an example in which the sheet M is reversed. FIG. 9 is different from FIG. 8 in that the sheet M is reversed around the X axis, i.e., the sheet M is horizontally reversed. Accordingly, the sheet M is fed with the edge (a third edge 44 illustrated in FIG. 9) corresponding to the trailing end illustrated in FIG. 6 in the conveyance direction as the edge corresponding to the leading end in the conveyance direction. The first image IMG1 is in a state of being formed on the back face by the reverse.

In step S0306, the image forming apparatus 1 desirably corrects the posture of the reversed sheet M.

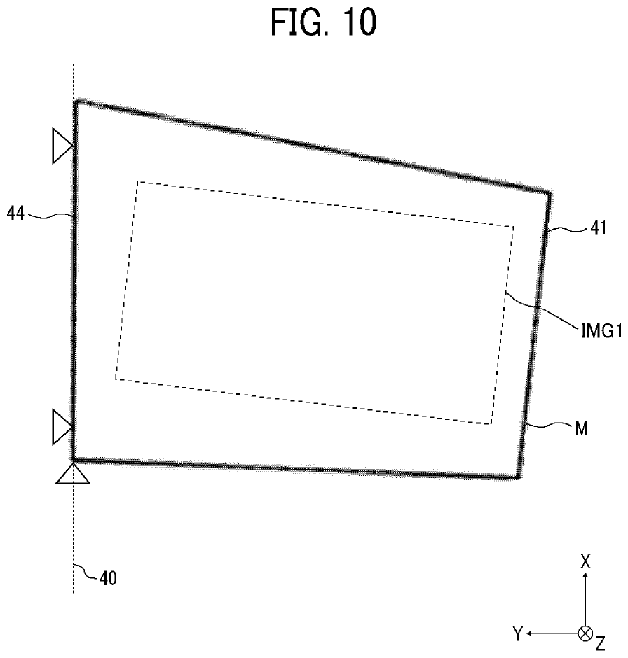

FIG. 10 is a diagram illustrating an example in which the posture of the sheet M is corrected after the reverse. FIG. 10 is different from FIG. 6 in that the posture of the sheet M is corrected such that the third edge 44 matches with the reference line 40 after the reverse.

In step S0307, the image forming apparatus 1 calculates the shape of the second face of the sheet M, i.e., the shape of the sheet M reversed from the first face to the second face.

In step S0308, the image forming apparatus 1 calculates a position where a second image IMG2 is to be formed on the second face of the sheet M.

In step S0309, the image forming apparatus 1 corrects the second image IMG2 to be formed on the second face of the sheet M.

In step S0310, the image forming apparatus 1 forms the corrected second image IMG2 on the second face of the sheet M. The processing results of step S0309 and step S0310 are described below.

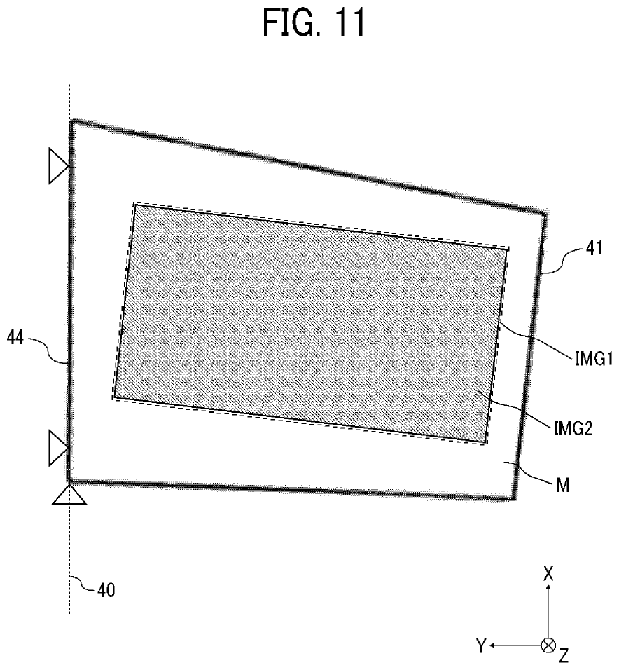

FIG. 11 is a diagram illustrating an example of correction and image formation of the second image IMG2 on the second face of the sheet M. As illustrated in the FIG. 11, the second image IMG2 is corrected and formed so as to be positioned on the back side of the first image IMG1.

The example illustrated in FIG. 11 is the correction in which the second image IMG2 is inclined such that the second image IMG1 matches the back side of the first image IMG2.

The correction is not limited to the processing illustrated in FIG. 11. The correction may be processing of changing the second image IMG2 such that the positions where the first image and the second image are formed match with each other on both sides. For example, the correction may be deformation, change of magnification, rotation, movement, or a combination of these processing of an image or a part of the image.

When the shape of the sheet M is detected, the image forming apparatus 1 can accurately align the second image IMG2 with the back surface of the first image IMG1. Specifically, when the shape of the sheet M is detected, the image forming apparatus 1 can recognize, for example, the shape of the sheet M in which the third edge 44 has the inclination γ with respect to the reference line 40. In a case where the shape of the sheet M is in a shape illustrated in FIG. 9, the posture of the sheet M is corrected as illustrated in FIG. 10, so that the sheet M is rotated by the inclination γ.

Such rotation of the sheet M is calculated based on the inclination γ (step S0308). Consequently, the image forming apparatus 1 can correct the second image IMG2 according to the inclination γ.

Note that FIG. 3 illustrates an example in which steps S0305 and S0306 and steps S0307 to S0309 are processed in parallel. However, these processing may not be performed in parallel. In other words, the steps S0305 and S0306 may be performed first and then, the steps S0307 to S0309 may be performed and vice versa.

### Second Embodiment

Compared to the first embodiment, a second embodiment is different in the overall processing as described below. Hereinafter, the points different from the first embodiment are mainly described, and duplicate descriptions are omitted.

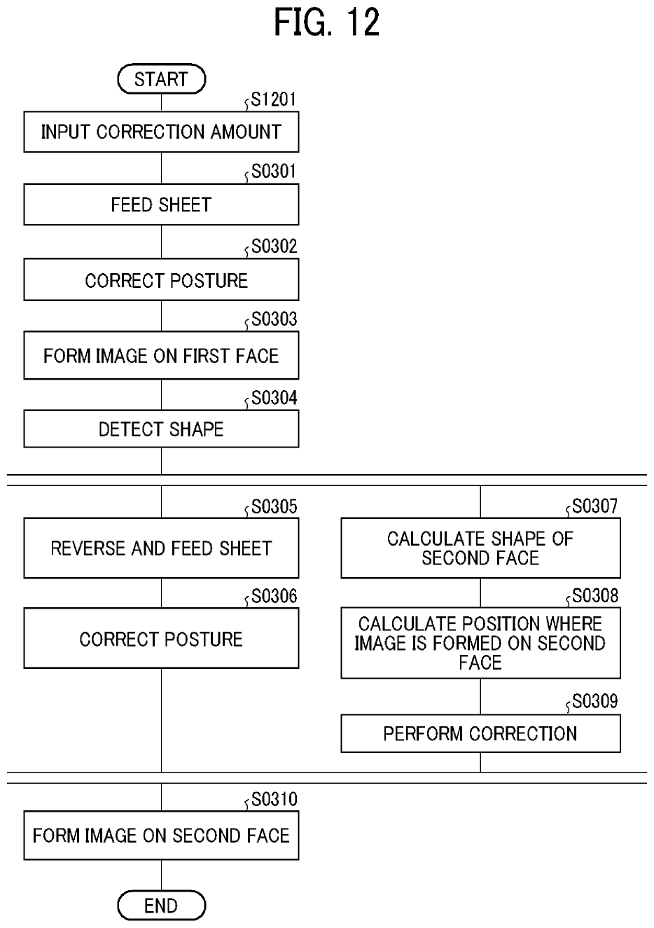

FIG. 12 is a flowchart of an example of overall processing according to the second embodiment of the present disclosure. The second embodiment is different from the first embodiment in that step S1201 is added.

In step S1201, the image forming apparatus 1 inputs a correction amount. The correction amount is, for example, a position at which the user designates to form an image is formed. For example, the correction amount is set by the user in advance. The correction amount is input by the user's operation through an input device.

Step S1201 may be performed at a timing other than the timing illustrated in FIG. 12. For example, step S1201 may be performed in parallel with other processing.

The correction is performed based on the correction amount and the detection result of the shape of the sheet M. For example, in a case where the amount of moisture contained in the sheet M is large, or in a special mode such as low-speed operation, the shape of the sheet M may severely deform. Consequently, the accuracy of an alignment may deteriorate. A user may set the second image IMG2 to be formed at a position other than the back side of the first image IMG1 due to, for example, user's preferences. As a result, the user inputs, for example, a position at which the second image IMG2 is desirably formed as a correction amount to the image forming apparatus 1 (step S1201).

The image forming apparatus 1 corrects the second image IMG2 such that the second image IMG2 is formed at the position indicated by the correction amount (step S0309). In this way, when the correction amount is input, the image forming apparatus 1 can form the second image IMG2 in accordance with user's preferences.

### Third Embodiment

Compared to the first embodiment, a third embodiment is different in the overall processing as described below. Hereinafter, the points different from the first embodiment are mainly described, and duplicate descriptions are omitted.

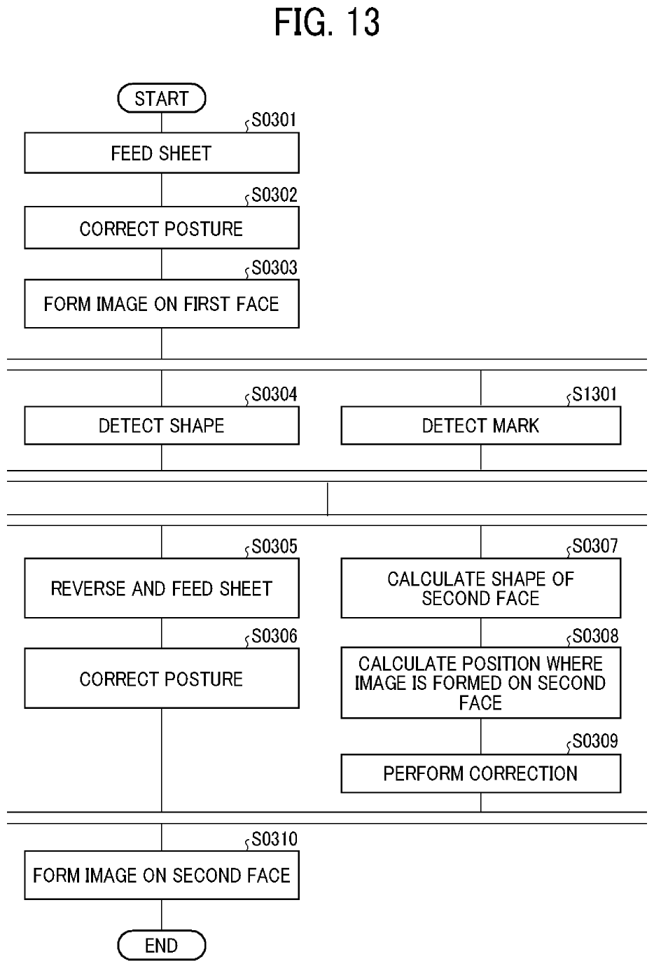

FIG. 13 is a flowchart of an example of overall processing according to the third embodiment of the present disclosure. The third embodiment is different from the first embodiment in that step S1301 is added.

In step S1301, the image forming apparatus 1 detects a mark.

The mark is formed on the sheet M in advance. Accordingly, the image forming apparatus 1 recognizes the shape of the mark in advance. In a case where the mark is formed on the sheet M, the image forming apparatus 1 can detect the position of the mark.

Then, the image forming apparatus 1 corrects the second image IMG2 in consideration of the detection result of the mark (step S0309). In this way, in a case where the mark is also used, the image forming apparatus 1 can more accurately align images to be formed on both sides of the sheet M.

Example of Functional Configuration

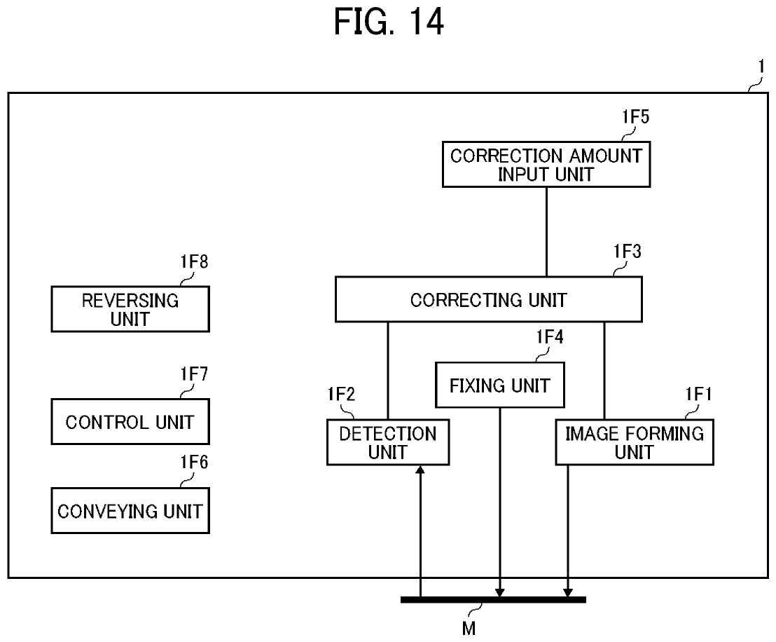

FIG. 14 is a diagram illustrating a functional configuration of an image forming apparatus 1 according to an embodiment of the present disclosure. The image forming apparatus 1 includes an image forming unit 1F1, a detection unit 1F2, and a correction unit 1F3. The image forming apparatus 1 preferably further includes a fixing unit 1F4, a correction amount input unit 1F5, a conveyance unit 1F6, a posture correcting unit 1F7, and a reversing unit 1F8.

The image forming unit 1F1 performs an image forming procedure for forming images on both sides of the sheet M. The image forming unit 1F1 is, for example, implemented with the printer 310 serving as an image forming device.

The detection unit 1F2 performs a detection procedure for detecting the shape of the sheet M. For example, the detection unit 1F2 is achieved by the reading device 401.

The correction unit 1F3 performs a correction procedure for correcting the second image IMG2 with respect to the first image IMG1 based on the shape of the sheet M. The correction unit 1F3 is, for example, implemented with the CPU 21.

The fixing unit 1F4 performs a fixing procedure for fixing the first image IMG1 to the sheet M. The fixing unit 1F4 is, for example, achieved by the fixing roller pair 15.

The correction amount input unit 1F5 performs a correction amount input procedure for inputting a correction amount. The correction amount input unit 1F5 is, for example, implemented with an input device.

The conveyance unit 1F6 performs a conveyance procedure for conveying the sheet M. The conveyance unit 1F6 is, for example, implemented with conveyance rollers.

The posture correcting unit 1F7 performs a correcting procedure for correcting the posture of the sheet M. The posture correcting unit 1F7 is, for example, implemented with the nip roller pair 31.

The reversing unit 1F8 performs a reversing procedure for reversing the first face and the second face. The reversing unit 1F8 is, for example, implemented with the sheet reverse passage 16.

When the image forming apparatus 1 forms images on both sides of the sheet M, the detection unit 1F2 first detects the shape of the sheet M. When the shape of the sheet M is detected, the image forming apparatus 1 can correct the second image IMG2 in accordance with the first image IMG1 based on the detection result of the shape of the sheet M. In other words, the image forming apparatus 1 can align images to be formed on both sides of the sheet M without using a detection mark as used in the related art. Such a configuration can obviate an area in which the detection mark is formed, thus preventing a user image area from being narrowed.

### Other Embodiment

The configuration of an image forming apparatus according to an embodiment of the present disclosure is not limited to the above-described configuration. For example, the image forming apparatus may include devices other than the devices described above. In addition, the arrangement of each device may be an arrangement other than the arrangement described above.

The recording medium may be, for example, a medium other than a sheet of paper or plain paper. For example, the recording medium may be coated paper, label paper, an overhead projector sheet, a film, or a flexible thin plate. In other words, the recording medium may be a material to which toner or ink droplets are at least temporarily adherable, a material to which toner or ink droplets adhere and are fixed, or a material to which toner or ink droplets adhere and permeate. Specific examples of the recording medium include, but are not limited to, a recording medium such as a sheet of paper, a film, or cloth, an electronic component such as an electronic substrate or a piezoelectric element (which may be referred to as a piezoelectric component), layered powder, an organ model, and a testing cell. In short, the recording medium is made of any material to which liquid is adherable, such as paper, thread, fiber, fabric, leather, metal, plastic, glass, wood, ceramic, or a combination thereof.

Each device described above may be a plurality of devices. In other words, each device may be configured such that a plurality of devices performs processing in a distributed manner, in a redundant manner, or in parallel. Alternatively, each device may be integrated. In other words, the plurality of devices described above may be achieved by one device.

The image forming method described above may be implemented with an image forming program. In other words, the image forming program causes devices such as an arithmetic device, a control device, and a storage device included in a computer to operate in cooperation with each other to implement the image forming method. The image forming program may be distributed via a computer-readable recording medium or an electric communication line.

It is therefore to be understood that the disclosure of the present specification may be practiced otherwise by those skilled in the art than as specifically described herein. Such embodiments and variations thereof are included in the scope and gist of the embodiments of the present disclosure and are included in the technical scope described in claims and the equivalent scope thereof.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

What is claimed is:

1. An image forming apparatus comprising:
an image forming device configured to form a first image on a first face of a recording medium and form a second image on a second face of the recording medium, the first face and the second face being on opposite sides of the recording medium;
a reading device configured to detect a shape of the recording medium; and
processing circuitry configured to correct the second image to be formed on the second face of the recording medium with respect to the first image formed on the first face of the recording medium based on the shape of the recording medium.

2. The image forming apparatus according to claim 1, further comprising a fixing device configured to fix the first image on the first face of the recording medium,
wherein the reading device is configured to detect the shape of the recording medium after the fixing device fixes the first image onto the first face of the recording medium.

3. The image forming apparatus according to claim 1,
wherein the reading device is configured to detect a mark on the recording medium, and
wherein the processing circuitry is configured to correct the second image to be formed on the second face of the recording medium based on the mark and the shape of the recording medium.

4. The image forming apparatus according to claim 1, further comprising an input device configured to input a correction amount; and
wherein the processing circuitry is configured to correct the second image to be formed on the second face of the recording medium based on the correction amount and the shape of the recording medium.

5. The image forming apparatus according to claim 1, further comprising:
a conveyance device configured to convey the recording medium;
a correction device configured to correct a posture of the recording medium on which the image forming device forms the first image or the second image; and
a reverse passage configured to reverse the first face and the second face of the recording medium,
wherein the reading device is configured to detect positions of four corners of the recording medium to detect the shape of the recording medium; and
wherein the processing circuitry is configured to:
calculate a shape of the second face of the recording medium after the first face and the second face of the recording medium are reversed through the reverse passage; and
correct a position at which the second image is formed and a magnification with which the second image is formed such that the second image is positioned on a back side of the first image in accordance with the shape of the second face.
